(19) United States
(12) Patent Application Publication
(10) Pub. No.: US 2017/0183482 A1
(43) Pub. Date: Jun. 29, 2017

(54) Rubber Composition and Pneumatic Tire Using Same

(71) Applicant: The Yokohama Rubber Co., LTD., Minato-ku, Tokyo (JP)

(72) Inventors: Ryutaro Nakagawa, Hiratsuka-shi, Kanagawa (JP); Yoshiaki Kirino, Hiratsuka-shi, Kanagawa (JP); Yusuke Tanabe, Hiratsuka-shi, Kanagawa (JP)

(73) Assignee: The Yokohama Rubber Co., LTD., Minato-ku, Tokyo (JP)

(21) Appl. No.: 15/129,787

(22) PCT Filed: Mar. 27, 2015
(86) PCT No.: PCT/JP2015/059609

§ 371 Date: Sep. 27, 2016

(30) Foreign Application Priority Data
Mar. 27, 2014 (JP) 2014-066373

(51) Int. Cl. C08L 9/00

(52) U.S. Cl. CPC C08L 9/00; C08L 2205/03

(57) ABSTRACT

The present technology provides a rubber composition comprising 100 parts by mass of (A) diene rubber, from 10 to 120 parts by mass of (B) carbon black, from 1 to 50 parts by mass of a (C) polyamide elastomer, and from 0.01 to 1.2 parts by mass of a (D) sulfenamide-based vulcanization retarder.

### TECHNICAL FIELD

The present technology relates to a rubber composition and a pneumatic tire using such a rubber composition; specifically, the present technology relates to a rubber composition of superior rigidity and breaking elongation, and to a pneumatic tire using the rubber composition.

### BACKGROUND ART

There is a demand for increased breaking elongation in tire sidewalls due to the large amounts of strain to which they are subjected. Meanwhile, tire bead fillers need to be highly rigid in order to suppress movement or separation of the bead cores and wrapped portions of the carcass layer. The practice of increasing the amount of reinforcing agent such as carbon black in order to increase bead filler rigidity is generally known; however, this practice leads to the problem of increased heat build-up.

There is thus a strong demand in the art for a rubber composition exhibiting both superior rigidity and breaking elongation.

International Patent Publication No. WO/2009/093695 discloses a rubber composition that contains from 0.1 to 50 parts by weight of a polyamide elastomer having a melting point of 100 to 180° C. and 1 to 100 parts by weight of an inorganic reinforcing agent per 100 parts by weight of vulcanizable rubber in order to improve elasticity, tensile strength, heat build-up, and fatigue properties.

However, such a polyamide elastomer is still incapable of increasing rigidity and breaking elongation to the levels demanded in the art, leaving room for improvement. In addition, the use of such a polyamide elastomer negatively affects scorch time T5 (the time at which an increase of five Mooney units over minimum Mooney viscosity occurs at an expected working temperature), leading to problems in terms of scorch properties.

### SUMMARY

The present technology provides a rubber composition containing a polyamide elastomer, wherein the composition yields superior rigidity, breaking elongation, and scorch stability, and a pneumatic tire using such a rubber composition.

As the result of diligent research, the inventors discovered that the object proposed above can be achieved by compounding specific amounts of carbon black and a polyamide elastomer into diene rubber, as well as a specific amount of a specific type of vulcanization retarder, thereby arriving at the present technology.

Specifically, the present technology is as follows.

1. A rubber composition comprising 100 parts by mass of (A) diene rubber, from 10 to 120 parts by mass of (B) carbon black, from 1 to 50 parts by mass of (C) a polyamide elastomer, and from 0.01 to 1.2 parts by mass of a (D) sulfenamide-based vulcanization retarder.

2. The rubber composition according to 1, wherein a mass ratio of the (C) polyamide elastomer to the (D) sulfenamide-based vulcanization retarder is 100:1 to 100:4.

3. The rubber composition according to 2, wherein the mass ratio of the (C) polyamide elastomer to the (D) sulfenamide-based vulcanization retarder is 100:1.5 to 100:2.5.

4. The rubber composition according to 1, wherein the (D) sulfenamide-based vulcanization retarder is N-cyclohexylthiophthalimide, N-phenyl-N-trichloromethylthiobenzenesulfonamide, N-isopropylthio-N-cyclohexylbenzothiazole-2-sulfonamide, or N-N′-N″-triisopropylthiophosphoric triamide.

5. The rubber composition according to 3, wherein the (D) sulfenamide-based vulcanization retarder is N-cyclohexylthiophthalimide.

6. The rubber composition according to 1, wherein the (B) carbon black has a nitrogen adsorption specific surface area (N₂SA) of 30 to 200 m²/g.

7. The rubber composition according to 6, wherein the (B) carbon black has a nitrogen adsorption specific surface area (N₂SA) of 50 to 150 m²/g.

8. The rubber composition according to 1, wherein the (C) polyamide elastomer has a soft segment Shore D hardness value at least 10 less than a hard segment Shore D hardness value thereof.

9. The rubber composition according to 8, wherein a difference between the soft segment Shore D hardness and the hard segment Shore D hardness of the (C) polyamide elastomer is 30 to 50.

10. The rubber composition according to 1, further comprising from 1.0 to 4.0 parts by mass of sulfur as a vulcanizing agent per 100 parts by mass of the (A) diene rubber.

11. The rubber composition according to 10, further comprising from 0.60 to 2.0 parts by mass of a vulcanization accelerator per 100 parts by mass of the (A) diene rubber, wherein the vulcanization accelerator is a sulfenamide-based vulcanization accelerator or a guanidine-based vulcanization accelerator.

12. A pneumatic tire wherein the rubber composition described in 1 is used.

In accordance with the present technology, specific amounts of carbon black and a polyamide elastomer, as well as a specific amount of a specific type of vulcanization retarder, are added to diene rubber, thereby allowing the provision of a rubber composition yielding superior rigidity, breaking elongation, and scorch stability, as well as a pneumatic tire using such a rubber composition.

### DETAILED DESCRIPTION

The present technology is described in further detail below.

### Diene Rubber

Any diene rubber that can be contained in a rubber composition may be used as the diene rubber (A) used in the present technology. Examples of diene rubber include natural rubber (NR), isoprene rubber (IR), butadiene rubber (BR), styrene-butadiene copolymer rubber (SBR), acrylonitrile-butadiene copolymer rubber (NBR), and the like. These may be used singly or in combinations of two or more types. There is no particular limitation upon the molecular weight and microstructure of the rubber component, which may be terminally modified with an amine, amide, silyl, alkoxysilyl, carboxyl, hydroxyl group, or the like, or may be epoxidized.

Of these various types of diene rubber, NR or BR is preferable in terms of yielding the effects of the present technology.

### Carbon Black

There is no particular limitation upon the carbon black used in the present technology and any carbon black ordinarily added to rubber compositions can be used. An example is carbon black having a nitrogen adsorption specific surface area (N₂SA) of 30 to 200 m²/g, preferably 50 to 150 m²/g. The nitrogen adsorption specific surface area (N₂SA) is a value calculated in accordance with JIS (Japanese Industrial Standard) K6217-2.

### Polyamide Elastomer

The polyamide elastomer constituting component (C) used in the present technology is a known elastomer, one of which is disclosed, along with a method for producing the elastomer, in International Patent Publication No. WO/2009/093695 listed above. The hard segments of the (C) polyamide elastomer are of polyamide, and the soft segments are of a multiblock copolymer composed of a polyether or a polyester. Examples of the material constituting the hard segments include nylon 6, 66, 610, 11, and 12. Examples of polyethers that can constitute the soft segments include polyethylene glycol, diol poly(oxytetramethylene) glycol, and poly(oxypropylene) glycol, and examples of polyesters include poly(ethylene adipate) glycol and poly(butylene-1,4-adipate) glycol. The soft segments can also be constituted by a block and/or multiblock copolymer of these materials.

A polyamide elastomer that is particularly preferable for yielding the effects of the present technology is a polyamide polyether elastomer comprising hard segments of nylon 12 and soft segments of polyether, the elastomer having a weight average molecular weight of 10,000 to 200,000. A commercially available version of such a polyether polyamide elastomer, such as UBESTA XPA P9040X1 manufactured by Ube Industries, Ltd., can be used.

It is preferable that the (C) polyamide elastomer have a soft segment Shore D hardness value at least 10 less than a hard segment Shore D hardness value thereof, as this will further improve the effects of the present technology. As used herein, soft segment and hard segment Shore D hardness refers to the hardness when the respective segments are measured as units; in the case of the aforementioned polyether polyamide elastomer, for example, the Shore D hardness of the polyether preferably has a value at least 10 less than the Shore D hardness of the nylon 12. The difference in Shore D hardness is more preferably 30 to 50.

Shore D hardness is measured in accordance with JIS K 6253.

### Sulfenamide-Based Vulcanization Retarder

The rubber composition of the present technology needs to contain a sulfenamide-based vulcanization retarder. In the present technology, the term sulfenamide-based vulcanization retarder refers to a vulcanization retarder containing an N—S bond. Phthalic anhydride, benzoic acid, salicylic acid, N-nitroso-diphenylamine, 2,4-diphenyl-4-methyl-1-pentene, and the like are known vulcanization retarders; however, adding these vulcanization retarders in the present technology will not allow the effects of the present technology to be obtained. Preferred examples of the sulfenamide-based vulcanization retarder used in the present technology include N-cyclohexylthiophthalimide, N-phenyl-N-trichloromethylthiobenzenesulfonamide, N-isopropylthio-N-cyclohexylbenzothiazole-2-sulfonamide, or N-N′-N″-triisopropylthiophosphoric triamide.

### Rubber Composition Compounding Ratios

The rubber composition of the present technology contains specific amounts of components (A) through (D). Specifically, the rubber composition of the present technology contains from 10 to 120 parts by mass of (B) carbon black, from 1 to 50 parts by mass of a (C) polyamide elastomer, and from 0.01 to 1.2 parts by mass of a (D) sulfenamide-based vulcanization retarder per 100 parts by mass of (A) diene rubber.

An amount of (B) carbon black less than 10 parts by mass is not preferable, as this will reduce reinforcement action and make it impossible to obtain the desired physical properties. Conversely, an amount exceeding 120 parts by mass will reduce dispersibility and degrade physical properties.

An amount of the (C) polyamide elastomer of less than 1 part by mass will be too little to yield the effects of the present technology. Conversely, an amount exceeding 50 parts by mass will negatively affect rigidity and heat build-up, and will lead to adhesion to the mixer and roll retention defects and otherwise negatively affect workability.

An amount of the (D) sulfenamide-based vulcanization retarder of less than 0.01 parts by mass will be too little to yield the effects of the present technology. Conversely, an amount exceeding 1.2 parts by mass will negatively affect vulcanization and cause blooming, potentially negatively affecting appearance.

The amount of (B) carbon black is preferably from 30 to 70 parts by mass per 100 parts by mass of the (A) diene rubber.

The amount of (C) polyamide elastomer is preferably from 5 to 30 parts by mass per 100 parts by mass of the (A) diene rubber.

The amount of (D) sulfenamide-based vulcanization retarder is preferably from 0.1 to 1.2 parts by mass per 100 parts by mass of the (A) diene rubber.

The rubber composition of the present technology preferably has a mass ratio of the (C) polyamide elastomer to the (D) sulfenamide-based vulcanization retarder of 100:1 to 100:4. A ratio outside of this range may negatively affect scorch time T5, and may reduce the effects of improving rigidity and breaking elongation.

The mass ratio of the (C) polyamide elastomer to the (D) sulfenamide-based vulcanization retarder is particularly preferably 100:1.5 to 100:2.5.

In addition to the aforementioned components, the rubber composition of the present technology can also contain various types of additives commonly added to rubber compositions, such as vulcanizing and cross-linking agents, vulcanizing and cross-linking accelerators, various types of oils, anti-aging agents, plasticizers, and the like. These additives may be mixed according to an ordinary method to form a composition, and used to perform vulcanization or cross-linking. Any conventional ordinary amount of these additives can be added to the extent that the object of the present technology is not hindered.

The amount of sulfur constituting the vulcanizing agent is preferably from 1.0 to 4.0 parts by mass per 100 parts by mass of the diene rubber. The vulcanization accelerator can be a sulfonamide-based vulcanization accelerator or a guanidine-based vulcanization accelerator, and preferably from 0.60 to 2.0 parts by mass thereof is added per 100 parts by mass of the diene rubber.

Examples of uses for the rubber composition of the present technology include conveyor belts, hoses, and tires; the composition is particularly preferably used in pneumatic tires, and is particularly advantageous for side treads and bead fillers by virtue of the superior rigidity and reduced heat build-up of the composition.

Additionally, the rubber composition produced according to the present technology can be used to manufacture a pneumatic tire according to a conventional method for manufacturing pneumatic tires.

### EXAMPLES

The present technology will now be described in further detail by way of working examples and comparative examples, but the present technology is not limited by these examples.

### Standard Example, Working Examples 1 to 7, and Comparative Examples 1 to 5

### Preparation of Samples

All of the components other than the vulcanization system (vulcanization accelerator, sulfur) were mixed for about three minutes and 30 seconds in a tangential mixer in the amounts (parts by mass) shown in Table 1, the vulcanization system was added to the obtained mixture, and the whole was mixed using an open roll to obtain a rubber composition. The rubber composition thus obtained was press-vulcanized in a predetermined mold at 160° C. for 15 minutes to fabricate a vulcanized rubber test strip. The physical properties of the obtained rubber composition and vulcanized rubber test strip were measured according to the following methods.

Scorch time (T5): Measured in accordance with JIS K 6300 using a Mooney viscometer (L rotor). The rotor was rotated at a test temperature of 125° C. after a preheating time of one minute, the minimum value (Vm) for Mooney viscosity of the obtained rubber composition on a Mooney viscosity-time curve was calculated, and the time necessary for viscosity to increase five Mooney units above Vm was measured and designated as T5. Results are expressed as index values against a value of 100 for a standard example. A larger index value indicates higher scorch resistance and more superior scorch stability. The tolerance range for T5 was to 10% less than the standard example.

100% modulus (M100): A tensile test was performed at 23° C. in accordance with JIS K 6251 to measure tensile stress at 100% elongation. Results are expressed as index values against a value of 100 for a standard example. A larger index value indicates more superior rigidity.

Breaking elongation: Breaking elongation was measured by a tensile test at room temperature in accordance with JIS K 6251. Results are expressed as index values against a value of 100 for a standard example. A larger index value indicates superior breaking elongation.

Results are shown in Table 1.

TABLE 1

| | Standard | Comparative | Comparative | Comparative | Comparative | Comparative |
|---|---|---|---|---|---|---|
| | Example | Example 1 | Example 2 | Example 3 | Example 4 | Example 5 |
| NR *1 | 35 | 35 | 35 | 35 | 35 | 35 |
| BR *2 | 65 | 65 | 65 | 65 | 65 | 65 |
| Polyamide | — | 15 | 15 | 15 | 15 | 30 |
| elastomer *3 | | | | | | |
| Carbon black *4 | 50 | 50 | 50 | 50 | 50 | 50 |
| Zinc oxide *5 | 3 | 3 | 3 | 3 | 3 | 3 |
| Stearic acid *6 | 1.5 | 1.5 | 1.5 | 1.5 | 1.5 | 1.5 |
| Anti-aging agent *7 | 3.25 | 3.25 | 3.25 | 3.25 | 3.25 | 3.25 |
| Wax *8 | 1 | 1 | 1 | 1 | 1 | 1 |
| Oil *9 | 12 | 12 | 12 | 12 | 12 | 12 |
| Sulfur *10 | 1.54 | 1.54 | 1.54 | 1.54 | 1.54 | 1.54 |
| Sulfur-containing | 0.8 | 0.8 | 0.8 | 0.8 | 0.8 | 0.8 |
| vulcanization | | | | | | |
| accelerator *11 | | | | | | |
| Sulfenamide-based | — | — | — | — | 1.5 | 3 |
| vulcanization | | | | | | |
| retarder *12 | | | | | | |
| Comparative | — | — | 0.3 | — | — | — |
| vulcanization | | | | | | |
| retarder 1 *13 | | | | | | |
| Comparative | — | — | — | 0.3 | — | — |
| vulcanization | | | | | | |
| retarder 2 *14 | | | | | | |
| (C):(D) | — | — | 100:2 | 100:2 | 100:10 | 100:10 |
| Test results | | | | | | |
| Scorch time (T5) | 100 | 28 | 31 | 37 | Note 1 | Note 1 |
| M100 | 100 | 119 | 132 | 124 | 116 | 142 |
| Breaking elongation | 100 | 108 | 95 | 107 | 112 | 115 |

| | Working | Working | Working | Working | Working | Working | Working |
|---|---|---|---|---|---|---|---|
| | Example 1 | Example 2 | Example 3 | Example 4 | Example 5 | Example 6 | Example 7 |
| NR *1 | 35 | 35 | 35 | 35 | 35 | 35 | 35 |
| BR *2 | 65 | 65 | 65 | 65 | 65 | 65 | 65 |
| Polyamide | 15 | 5 | 5 | 15 | 15 | 30 | 30 |
| elastomer *3 | | | | | | | |
| Carbon black *4 | 50 | 50 | 50 | 50 | 50 | 50 | 50 |
| Zinc oxide *5 | 3 | 3 | 3 | 3 | 3 | 3 | 3 |
| Stearic acid *6 | 1.5 | 1.5 | 1.5 | 1.5 | 1.5 | 1.5 | 1.5 |
| Anti-aging agent *7 | 3.25 | 3.25 | 3.25 | 3.25 | 3.25 | 3.25 | 3.25 |
| Wax *8 | 1 | 1 | 1 | 1 | 1 | 1 | 1 |
| Oil *9 | 12 | 12 | 12 | 12 | 12 | 12 | 12 |
| Sulfur *10 | 1.54 | 1.54 | 1.54 | 1.54 | 1.54 | 1.54 | 1.54 |
| Sulfur-containing | 0.8 | 0.8 | 0.8 | 0.8 | 0.8 | 0.8 | 0.8 |
| vulcanization | | | | | | | |
| accelerator *11 | | | | | | | |
| Sulfenamide-based | 0.3 | 0.05 | 0.2 | 0.15 | 0.6 | 0.3 | 1.2 |
| vulcanization | | | | | | | |
| retarder *12 | | | | | | | |
| Comparative | — | — | — | — | — | — | — |
| vulcanization | | | | | | | |
| retarder 1 *13 | | | | | | | |
| Comparative | — | — | — | — | — | — | — |
| vulcanization | | | | | | | |
| retarder 2 *14 | | | | | | | |
| (C):(D) | 100:2 | 100:1 | 100:4 | 100:1 | 100:4 | 100:1 | 100:4 |
| Test results | | | | | | | |
| Scorch time (T5) | 100 | 90 | 125 | 93 | 138 | 91 | 130 |
| M100 | 132 | 105 | 108 | 121 | 118 | 146 | 150 |
| Breaking elongation | 108 | 101 | 102 | 110 | 109 | 108 | 108 |

Note 1:
T5 not reached even after maximum measurement time of 45 minutes.
*1: NR (NUSIRA SIR20)
*2: BR (Nipol BR1220, manufactured by Zeon Corporation)
*3: Polyamide elastomer (UBESTAXPA P9040X1, manufactured by Ube Industries, Ltd.)
*4: Carbon black (Sho Black N550, manufactured by Cabot Japan Co., Ltd.; N₂SA = 42 m²/g)
*5: Zinc oxide (Zinc Oxide #3, manufactured by Seido Chemical Industry Co., Ltd.)
*6: Stearic acid (Stearic Acid, manufactured by NOF Corp.)
*7: Anti-aging agent (Antigen 6C, manufactured by Sumitomo Chemical Co., Ltd.)
*8: Wax (SANNOC, manufactured by Ouchi Shinko Chemical Industrial Co., Ltd.)
*9: Oil (Extract No. 4S, manufactured by Showa Shell Sekiyu K.K.)
*10: Sulfur (oil-treated sulfur, manufactured by Karuizawa Refinery Ltd.)
*11: Sulfur-containing vulcanization accelerator (Sanceller CM-P0, manufactured by Sanshin Chemical Industry Co., Ltd.; sulfenamide-based vulcanization accelerator)
*12: Sulfenamide-based vulcanization retarder (Pilgard PVI, manufactured by Nocil Ltd.; N-cyclohexylthiophthalimide)
*13: Comparative vulcanization retarder 1 (Sconoc, manufactured by Ouchi Shinko Chemical Industrial Co., Ltd.; N-nitroso-diphenylamine)
*14: Comparative vulcanization retarder 2 (Sconoc 7, manufactured by Ouchi Shinko Chemical Industrial Co., Ltd.; phthalic anhydride)

As is clear from Table 1, Working Examples 1 to 7, in which specific amounts of the (B) carbon black, the (C) polyamide elastomer, and the (D) sulfenamide-based vulcanization retarder are contained, yielded rubber compositions exhibiting superior rigidity, breaking elongation, and scorch properties compared to the standard example.

By contrast, Comparative Example 1, in which the (D) sulfenamide-based vulcanization retarder is not contained, exhibited worsening of scorch time T5.

Comparative Example 2, in which N-nitrosodiphenylamine is contained instead of the (D) sulfenamide-based vulcanization retarder, exhibited worsening of scorch time T5 and breaking elongation.

Comparative Example 3, in which phthalic anhydride is contained instead of the (D) sulfenamide-based vulcanization retarder, exhibited worsening of scorch time T5.

Comparative Examples 4 and 5, in which the compounded amount of the (D) sulfenamide-based vulcanization retarder exceeded the maximum set forth in the present technology, resulted in a negative effect upon vulcanization.

1. A rubber composition comprising 100 parts by mass of (A) diene rubber, from 10 to 120 parts by mass of (B) carbon black, from 1 to 50 parts by mass of a (C) polyamide elastomer, and from 0.01 to 1.2 parts by mass of a (D) sulfenamide-based vulcanization retarder.

2. The rubber composition according to claim 1, wherein a mass ratio of the (C) polyamide elastomer to the (D) sulfenamide-based vulcanization retarder is 100:1 to 100:4.

3. The rubber composition according to claim 2, wherein the mass ratio of the (C) polyamide elastomer to the (D) sulfenamide-based vulcanization retarder is 100:1.5 to 100:2.5.

4. The rubber composition according to claim 1, wherein the (D) sulfenamide-based vulcanization retarder is N-cyclohexylthiophthalimide, N-phenyl-N-trichloromethylthiobenzenesulfonamide, N-isopropylthio-N-cyclohexylbenzothiazole-2-sulfonamide, or N-N′-N″-triisopropylthiophosphoric triamide.

5. The rubber composition according to claim 3, wherein the (D) sulfenamide-based vulcanization retarder is N-cyclohexylthiophthalimide.

6. The rubber composition according to claim 1, wherein the (B) carbon black has a nitrogen adsorption specific surface area (N₂SA) of 30 to 200 m²/g.

7. The rubber composition according to claim 6, wherein the (B) carbon black has a nitrogen adsorption specific surface area (N₂SA) of 50 to 150 m²/g.

8. The rubber composition according to claim 1, wherein the (C) polyamide elastomer has a soft segment Shore D hardness value at least 10 less than a hard segment Shore D hardness value thereof.

9. The rubber composition according to claim 8, wherein a difference between the soft segment Shore D hardness and the hard segment Shore D hardness of the (C) polyamide elastomer is 30 to 50.

10. The rubber composition according to claim 1, further comprising from 1.0 to 4.0 parts by mass of sulfur as a vulcanizing agent per 100 parts by mass of the (A) diene rubber.

11. The rubber composition according to claim 10, further comprising from 0.60 to 2.0 parts by mass of a vulcanization accelerator per 100 parts by mass of the (A) diene rubber, wherein the vulcanization accelerator is a sulfenamide-based vulcanization accelerator or a guanidine-based vulcanization accelerator.

12. A pneumatic tire wherein the rubber composition described in claim 1 is used.
